(19) United States
(12) Patent Application Publication
(10) Pub. No.: US 2011/0220248 A1
(43) Pub. Date: Sep. 15, 2011

(54) POROUS MAGNESIA CLINKER, MANUFACTURING METHOD AND USE THEREOF AS FLUX FOR TREATING STEELMAKING SLAG

(75) Inventors: Sabine Guichard, L'lsle D'Abeau (FR); Herve Fryda, Meyrie (FR); Christoph Wohrmeyer, Dusseldorf (DE); Remy Jolly, Boulogne Billancourt (FR); Enrique Elorza, Lyon (FR)

(73) Assignee: KERNEOS, Neuilly-sur-Seine (FR)

(21) Appl. No.: 13/130,181

(22) PCT Filed: Nov. 17, 2009
(86) PCT No.: PCT/FR2009/052204

§ 371 Date: May 19, 2011

(30) Foreign Application Priority Data
Nov. 19, 2008 (FR) 0857847

(51) Int. Cl. B23K 35/34

(52) U.S. Cl. 148/26; 148/22

(57) ABSTRACT

A clinker composition including, relative to the clinker total weight:
from 30 to 85% Al₂O₃;
from 3 to 45% CaO;
from 9 to 45% MgO
   and having an apparent porosity, such as measured by means of the apparent porosity underwater measurement assay according to modified NF B40-312 standard ranging from 4% to 60%.

The present invention generally relates to a magnesia-rich clinker particularly useful as a flux for treating slags from steel-making ladles.

As used herein, a “clinker” is intended to mean any product resulting from the high-temperature processing (>1200° C.) of intimately combined materials mostly composed of a CaO source and of a Al₂O₃ source.

Fluxes are mineral compositions that are added to the slag from the steel-making ladles so as to facilitate the fluidization thereof. These slags are especially used in secondary metallurgy and enable to purify steel and especially to desulfurize it. The main function of such fluxes is indeed to act as a fluxing agent to fluidify the slag which then improves interchanges with steel melt. As a major drawback, these slags do cause the ladle refractory linings to corrode, the latter also comprising MgO that dissolves into the slag melt.

Traditional fluxes include mineral compositions mostly composed of Al₂O₃ and CaO (especially in the form of calcium aluminates) and are typically obtained by melting alumina and lime or precursors of such compounds.

The U.S. Pat. No. 4,795,491 describes a calcium aluminate-based flux for desulfurizing liquid steel in steel-making ladles. This flux comprises from 9 to 20% by weight of MgO. Such synthetic fluxes are obtained by melting components above their melting points which provides products having a very low apparent porosity (typically of less than 1% such as measured under the following assay “apparent porosity underwater measurement” as defined hereunder). This patent mentions that using magnesium oxide (MgO) in the synthetic flux reduces the damages to the ladle refractory linings, which linings themselves also comprise MgO that dissolves into the slag melt. Thus, adding MgO through the flux to the slag melt makes it possible to reduce MgO loss through corrosion of the refractory linings.

However, the synthetic fluxes of U.S. Pat. No. 4,795,491 because of their low porosity and their limited exchange surface may suffer from the drawback of slowly dissolving or dispersing into the slag melt, which causes MgO to be slowly released into the slag melt.

Moreover, preparing a flux having a magnesia content of up to 20% by weight by means of a melting process requires to work under very high temperatures, which is detrimental to energy consumption, carbon dioxide production, furnace service life, etc.

Lastly, dense synthetic fluxes, such as those obtained by melting, as a further drawback are prone to “dusting”, that is to say to degrade as time goes and form fine particles (less than 1 mm in size) which interfere with handleability of these granular fluxes leading to hygiene and industrial safety problems.

The US patent application N^{o} 2007/0,000,350 describes a covering agent in the form of grains having a chemical and a mineralogical composition required for use in metallurgy and which forms both the slag melt and, deposited thereonto, due to the suitable grain porosity, a thermal barrier layer on the melt. Such covering agent which was made porous is based on calcium aluminates with a CaO/Al₂O₃ ratio ranging from 0.25 to 4 and may comprise up to 15% by weight of optional auxiliary phases, especially MgO and/or MgOSiO₂ and/or TiO₂ and/or Fe₂O₃ and/or alkaline metals. Porosity may vary from 5 to 70% in volume. The major aim for this covering agent is to form a solid granular layer that provides a heat shield above the melt.

It is thus an object of the present invention to provide a clinker for use as a flux during the steel production process. These useful clinkers remedy to the drawbacks of the fluxes from the prior art. Very especially, they quickly dissolve or disperse into the slag melt, even if the flux comprises MgO high contents (>20% by weight) so as to quickly obtain an at least partial MgO saturation of the slag.

It is also an object of the present invention to provide a clinker such as previously defined that would less tend to form dust and that would therefore substantially contribute to an improvement of the hygiene and security conditions when handled in industrial environments.

It is a further object of the present invention to provide a method for making clinker, in particular by sintering, as well as the use thereof as a flux especially for preparing steel-making ladle slags.

It is another object of the present invention to provide a product resulting from the crushing/screening of a clinker such as previously defined.

The present invention also relates to the use as a flux of the clinker-derived product. It can be used, for example, to form secondary metallurgy slags used for steel purification, especially desulfurization or for providing a covering to the steel continuous distributor.

According to the present invention, the hereabove mentioned objectives are aimed at by a clinker comprising, relative to the clinker total weight:
as regards its chemical composition

from 30 to 85% Al₂O₃

from 3 to 45% CaO

from 9% to 45% MgO
as regards its mineralogical composition

from 15 to 65% of the Q phase

from 5 to 40% of the MgAl₂O₄ phase

and having an apparent porosity, such as measured by means of the apparent porosity underwater measurement assay according to modified NF B40-312 standard, such as described hereunder, ranging from 4% to 60%, preferably ranging from 5 to 45%.

It is a further object of the present invention to provide a method for reducing the clinker tendency to form dust with a size of less than 1 mm, the chemical composition of said clinker comprising, relative to the clinker total weight:

from 30 to 85% Al₂O₃

from 3 to 45% CaO

from 9 to 45% MgO,

characterized in that it consists in providing said clinker with an apparent porosity according to modified NF B 40-312 standard ranging from 4% to 60%, preferably ranging from 4 to 45%, more preferably ranging from 4 to 20% and even more preferably ranging from 4 to 10%.

As used herein, an “apparent porosity” means that all the pores in a solid material go through the same to the outside, either directly, or through interconnections.

As previously stated, the clinkers of the invention comprise as to their chemical composition, from 30 to 85%, more preferably from 35 to 65% and even more preferably from 35 to 55% of alumina (Al₂O₃) by weight of the clinker total weight.

Preferably, the clinkers of the invention comprise as to their chemical composition from 10 to 40% by weight, more preferably from 15 to 35% by weight, of CaO.

The clinkers of the invention, as to their chemical composition, comprise at least 9% by weight, typically at least 15% by weight and preferably at least and more preferably more than 20% to 45% by weight of MgO.

Preferably, alumina (Al₂O₃), lime (CaO) and magnesia (MgO) all together account for at least 50%, preferably at least 70% of the clinker total weight.

In addition, the clinker of the invention comprises some silica (SiO₂) at least in an amount sufficient to obtain the Q phase minimum amount required.

The clinker of the invention comprises typically from 0.5 to 20%, preferably from 0.5 to 10% and more preferably at least 1% of silica (SiO₂) relative to the clinker total weight.

As is well known, the clinker of the invention may also comprise other oxides:

| | % by weight relative to the clinker |
|---|---|
| Oxides | total weight |
| Fe₂O₃ | 0-50 |
| TiO₂ | 0-20 |
| Na₂O, K₂O, P₂O₅, B₂O₃, SO₃, metal | 0-20 |
| oxides, such as Cr₂O₃, Mn₂O₃ . . . | |

The raw materials used are typically bauxite, alumina, calcite, dolomite, magnesia or any other raw materials and by-products containing the hereabove mentioned oxides.

In a particularly preferred embodiment of the present invention, the clinkers of the invention, as to their chemical composition, comprise 15%, more preferably 20%, and even more preferably more than 20% by weight of MgO.

Generally, the clinkers of the invention comprise, relative to the clinker total weight from 5 to 25% of free MgO (periclase).

One of the clinker of the invention main characteristics is their substantial apparent porosity, that specifically accounts for at least 4% such as measured in the apparent porosity underwater measurement assay as defined hereunder.

Preferably, the clinkers of the invention have an apparent porosity, such as determined by means of the following underwater measurement assay, ranging from 4 to 60%, preferably from 4 to 45%, more preferably from 4 to 20% and even more preferably from 4 to 10%.

As a rule, in the clinkers of the invention, all the mineralogical phases Ca₁₂Al₁₄O₃₃, (C₁₂A₇), Ca₂₀Al₃₂₋₂ₓMgₓSiₓO₆₈ (2.5≦x≦3.5, phase Q), MgAl₂O₄ (spinel) and MgO (periclase) account for at least 30% of the clinker total weight, preferably for at least 40% and more preferably for at least 50% of the clinker total weight.

Q and MgAl₂O₄ mineralogical phases may represent respectively, relative to the clinker total weight, from 15 to 65% for the Q phase and from 5 to 40% for MgAl₂O₄. Preferably the Q phase accounts for 20 to 65% by weight of the clinker and the MgAl₂O₄ phase accounts for 5 to 30% by weight of the clinker.

Preferably, the clinkers of the invention also comprise from 2 to 15%, more preferably from 4 to 12% relative to the clinker total weight of the Ca₁₂Al₁₄O₃₃ (C₁₂A₇) phase.

Generally, the presence of MgO in calcium aluminate clinkers tends to increase the clinker melting temperature. The mineralogical composition of the clinkers of the invention makes it possible to obtain clinkers having relatively low global melting temperatures, i.e. temperatures ranging typically from 1300 to 1800° C. (DIN 51730 standard).

The clinkers of the invention may be obtained by sintering the basic components at a temperature ranging from 1200 to 1500° C. for a time period between 15 minutes and 1 hour, typically in rotary furnaces such as those used for making cement, and if necessary by milling the resulting sintered product to the expected size grading. For use in secondary metallurgy, it is usual to work with the size-fraction of the product resulting from screening/crushing that is less than 25 mm.

Sintering is a bonding process effected by reacting powdered materials in a solid state at a lower temperature than that forming a liquid phase.

However, for sintering, a small amount of the product in a liquid phase may be accepted during the sintering process provided that the solid phase still prevails, preferably be present in a minimum proportion of 70% by weight relative to the composition total weight.

The sintering method of the invention is of course very different from the traditional melting method wherein all the components are heated to ensure the complete melting of the product so that the reaction occurs in the liquid phase.

The clinkers of the invention have a particle size of more than 1 mm and up to 50 mm, preferably up to 25 mm.

As previously mentioned, the clinkers of the invention are less prone to dusting than clinkers and fluxes of the prior art, especially dense fluxes obtained by melting methods. As used herein, “prone to dusting” is intended to mean that as time goes and/or under particular conditions, especially after the stability assay in autoclave as defined hereunder, the fraction of those particles of less than 1 mm in size significantly increases, which is the case with magnesia-rich fluxes having a low apparent porosity which are typically obtained by means of a melting method. As a rule, the clinkers of the invention after the stability test have a fraction of <1 mm particles of less than 1% by weight.

Without wishing to be bound to any particular theory, the applicant believes that apparent porosity is an important parameter as regards dusting of magnesia-rich fluxes. Indeed, free magnesia (periclase) does react with water to form brucite, which creates an expansion phenomenon.

Whatever the magnesia-rich clinker, free magnesia will react with atmospheric water to form brucite. With a dense clinker (low apparent porosity), the brucite formation will lead to an expansion- and cracking-induced bursting of the clinker, thus increasing the specific surface of the clinker and the eventuality of making MgO react and therefore of dusting.

With the porous clinkers of the invention, the fact that there are pores makes it possible to accommodate the brucite formation with no bursting of the clinker, thus significantly minimizing the risk of dusting.

Underwater Porosity Measurement (According to Modified NFB 40-312 Standard)
Collecting about 50 g of clinker having a size grading of more than 5 mm;
Introducing the same into a sieve with a smaller mesh size and gently blowing thereonto using compressed air so as to remove any optional fine particle therefrom;
Weighting a dry clinker sample and recording the weight P_{S};
Placing the clinker sample in a cupel and putting the cupel under a vacuum chamber bell jar connected to a vacuum pump and fitted with a water supply;
Starting the vacuum pump and allowing vacuum to operate for around 15 minutes until reaching a vacuum value of 200 mbars.
Gently opening the water valve while allowing the vacuum pump to operate and filling with water until the water level comes one centimeter above the clinker sample;
Letting the vacuum pump run for at least one hour so as to maintain a 200 mbar-vacuum until there are no more bubbles emerging to the surface;
Stopping the vacuum pump and opening the vacuum chamber bell jar;
Placing the sample in the screen of a previously tared hydrostatic balance and weighting, keeping the sample dipped underwater and recording the weight P_{L}.
Gently recovering the clinker sample once the pores are filled with water and slightly wiping the same with a sponge;
Quickly weighting the clinker sample and recording the weight P_{H}.

The apparent porosity as expressed in % is as follows:

[(P_{H}−P_{S})/(P_{H}−P_{L})]×100.

Stability Assay in Autoclave

Such assay makes it possible to determine the dusting tendency of the clinkers.
Crushing the material so as to obtain a size grading ranging from 1 to 3.15 mm (as determined through sieving)
Weighting 50 g of the crushed clinker sample;
Placing the sample in a beaker and the beaker in an autoclave (approx. 60 cm³), into which a cupel containing 1 ml water is also introduced;
Closing the autoclave and placing the same in an oven at 150° C. for 24 hours;
After discharging from the oven and cooling, opening the autoclave and recovering the sample (visually checking the occurrence of dusting inside the beaker);
Weighting the sample and recording the weight P1;
Screening the sample with a <1 mm mesh (oversized 1 mm or more; passing material=less than 1 mm), recovering the fines, weighting the same and recording the weight P2;
Calculating the dusting ratio (%)=P2/P1×100

### EXAMPLES

Clinkers were prepared, having the chemical and mineralogical compositions given in Tables 1 and 2 hereunder.

TABLE 1
Chemical composition (% by weight)

| | Al₂O₃ | CaO | SiO₂ | MgO | Other oxides |
|---|---|---|---|---|---|
| Clinker n^{o} 1 | 44.9 | 36.6 | 3.8 | 10.4 | balance to 100 |
| (sintered) | | | | | |
| Clinker n^{o} 2 | 39.7 | 32.1 | 3.8 | 20.7 | balance to 100 |
| (sintered) | | | | | |
| Clinker n^{o} 3 | 38.9 | 26.6 | 3.6 | 27.4 | balance to 100 |
| (sintered) | | | | | |
| Clinker A | 39.6 | 31.9 | 3.8 | 20.6 | balance to 100 |
| (melt) | | | | | |
| Clinker B | 39.2 | 26.0 | 3.4 | 27.1 | balance to 100 |
| (melt) | | | | | |

TABLE 2
Mineralogical composition (% by weight)

| Clinker | CA | C12A7 | Q Phase | MgAl₂O₄ | MgO | Other |
|---|---|---|---|---|---|---|
| 1 | 10 | 11 | 43 | 8 | 7 | 21 |
| 2 | 0 | 4 | 64 | 6 | 17 | 9 |
| 3 | 12 | 10 | 26 | 11 | 24 | 17 |
| A | 1 | 5 | 58 | 8 | 18 | 10 |
| B | 1 | 7 | 38 | 21 | 21 | 12 |

Clinkers 1 to 3 are porous magnesia-rich clinkers according to the invention obtained by sintering and clinkers A and B are dense magnesia-rich clinkers obtained by melting given as comparative examples.

The clinkers were produced by preparing a raw mix by granulating fine raw materials in the required amounts to obtain the expected chemical and mineralogical compositions and by placing the raw mixes in platinum crucibles. The crucibles were then introduced into a laboratory furnace and the furnace temperature was raised at a rate of 20° C./minute, up to a hold at 900° C., then to the working temperature so that the whole lime is combined, thereafter the crucibles are maintained at this temperature for one hour. Depending on the expected composition, the working temperature will be set within a range ranging from 1250 to 1500° C. in order to adjust the porosity within the required range.

The working temperatures are given hereunder.

| Clinker n^{o} | Working temperature (° C.) |
|---|---|
| 1 | 1330-1350 |
| 2 | 1350-1370 |
| 3 | 1280-1300 |
| A | 1500 |
| B | 1500 |

The underwater apparent porosity of the different clinkers were measured according to the previously described test protocol.

The results are given in the table hereunder.

| Clinker n^{o} | Underwater apparent porosity (%) |
|---|---|
| 1 | 34.7 |
| 2 | 5.2 |
| 3 | 4.5 |
| A | 0.8 |
| B | 0.6 |

Clinkers n^{o} 1, 2 and 3 according to the invention as well as comparative clinkers A and B were submitted to the stability test in autoclave as defined hereabove. It could be visually observed that there was not any powder on the clinkers prior to the test. The results are given in the table hereunder.

Size Grading (Screening)

| | Passing at | Passing at 1 | Oversized at |
|---|---|---|---|
| | 500 μm | mm | 1 mm |
| Clinker | (% by weight) | (%) | (%) |
| 1 | ND | 0.71 | 99.29 |
| 2 | 0.03 | 0.06 | 99.94 |
| 3 | 0.17 | 0.25 | 99.75 |
| A | 2.24 | 3.55 | 96.45 |
| B | 2.73 | 4.37 | 95.63 |

ND: not determined.

These tests show that the porous clinkers of the invention are significantly less prone to fine dusting than a same dense clinker.

The mineralogical analyses of products having a size grading lower than and/or higher than 1 mm after the test in autoclave are given in the following table hereunder:

Mineralogical Composition after the Test in Autoclave (% by Weight)

| Clinker | Mg(OH)₂ | C₃AH₆ | Other |
|---|---|---|---|
| 1 >1 mm | 4 | 10 | Balance to 100 |
| 2 >1 mm | 4 | 0 | Balance to 100 |
| 3 >1 mm | 1 | 7 | Balance to 100 |
| A >1 mm | 0 | 0 | Balance to 100 |
| B >1 mm | 1 | 0 | Balance to 100 |
| B <1 mm | 3 | 5 | Balance to 100 |

Despite a high amount of hydrates (especially of brucite which is very prone to expand) in high apparent porosity products, there was no dusting. In the same time, low apparent porosity products did generate a high amount of dust and very few hydrates (essentially resulting from fines <1 mm). With porous clinkers, the presence of pores accommodates the formation of brucite preventing the bursting of the clinker, which significantly minimizes the risk of dusting.

1. A clinker comprising, relative to the clinker total weight:
as regards its chemical composition:
from 30 to 85% Al₂O₃;
from 3 to 45% CaO;
from 9% to 45% MgO
as regards its mineralogical composition:
from 15 to 65% of the Q phase
from 5 to 40% of the MgAl2O4 phase
and having an apparent porosity, such as measured by means of the apparent porosity underwater measurement assay according to modified NF B40-312 standard ranging from 4% to 60%.

2. A clinker according to claim 1, wherein the apparent porosity ranges from 4 to 45%.

3. A clinker according to claim 1, which as regards its chemical composition comprises at least 15% and more preferably at least 20% or more, by weight, of MgO.

4. A clinker according to claim 1, which comprises from 35 to 65%, preferably from 35 to 55% by weight of Al₂O₃.

5. A clinker according to claim 1, which as regards its mineralogical composition comprises from 20 to 65% by weight of a Q phase and from 5 to 30% by weight of a MgAl₂O₄ phase.

6. A clinker according to claim 1 which as regards its mineralogical composition comprises from 2 to 15% by weight, preferably from 4 to 12%, of a C12A7 phase.

7. A method for making a clinker according to claim 1 which comprises the steps consisting in:
mixing Al₂O₃, CaO and MgO or precursors of such compounds in suitable amounts for obtaining the expected Al₂O₃, CaO and MgO contents; and
sintering the mixture.

8. A method according to claim 7, wherein said sintering is performed at a temperature ranging from 1200° C. to 1500° C.

9. A product resulting from the crushing/screening of a clinker according to claim 1.

10. A method for steel purification, especially for steel desulfurization, comprising preparing secondary metallurgy slags with a flux, wherein a product derived from a clinker according to claim 9 is used as the flux.

11. A method for preparing a covering for a steel continuous distributor, comprising adding a product derived from a clinker according to claim 9 to the covering.

12. A method for reducing the clinker tendency to form dust with a size of less than 1 mm, said clinker comprising, relative to the clinker total weight:
from 30 to 85% Al₂O₃
from 3 to 45% CaO
from 9%, preferably at least from 15% and more preferably from 20% or more, to 45% of MgO, characterized in that it consists in providing said clinker with an apparent porosity according to modified NF B 40-312 standard ranging from 4% to 60%, preferably ranging from 4 to 45%, more preferably ranging from 4 to 20% and even more preferably ranging from 4 to 10%.

13. A method according to claim 12, wherein the clinker, as regards its chemical composition, comprises from 20 to 45% of MgO relative to the clinker total weight.
